(19) United States
(12) Patent Application Publication
(10) Pub. No.: US 2013/0019253 A1
(43) Pub. Date: Jan. 17, 2013

(54) Automatic Discovery of Application Infrastructure

(71) Applicants: Sunil Joseph, Sacramento, CA (US); Michael Haeuptle, Rocklin, CA (US); James Branen, Roseville, CA (US); Bill Furnas, Granite Bay, CA (US); Yanhua Li, Rocklin, CA (US)

(72) Inventors: Sunil Joseph, Sacramento, CA (US); Michael Haeuptle, Rocklin, CA (US); James Branen, Roseville, CA (US); Bill Furnas, Granite Bay, CA (US); Yanhua Li, Rocklin, CA (US)

(21) Appl. No.: 13/182,840

(22) Filed: Jul. 14, 2011

(51) Int. Cl. G06F 9/44

(52) U.S. Cl. 719/328

(57) ABSTRACT

A method for automatically discovering application infrastructure for actively monitored transactions includes observing an activity and synthetic transaction using a diagnostic agent deployed into a process space of an application server. Application components are identified based on the synthetic transaction, and the application infrastructure is identified based on the application components.

### BACKGROUND

Conducting business over the Internet is now common place, as businesses typically buy, sell, and collaborate via the World Wide Web. Various web interfaces provide the “face” of businesses online, allowing customers to interact with businesses while giving businesses a cost effective manner to provide various services to their customers. Business process management focuses on ensuring that a business is fulfilling the needs of its customers in a quality and cost effective manner.

In order to ensure continued business productivity, income, and customer loyalty, an information technology (IT) group may desire high availability and performance of business applications. Enterprise IT departments typically include one or more monitoring teams that may use various tools to detect, isolate, diagnose, repair, and prevent issues with the enterprise business applications. To accomplish this efficiently, monitoring teams may have insight into the performance of business transactions, the related application, and infrastructure components that host the application. Monitoring teams may manually ascertain and record the application and infrastructure relationship, or the teams may have a detailed knowledge of the application deployment in a particular system. With this knowledge, monitoring teams can quickly identify the components that are negatively impacting the business transaction's performance.

### BRIEF DESCRIPTION OF THE DRAWINGS

Certain exemplary embodiments are described in the following detailed description and in reference to the drawings, in which:

FIG. 1 is a process flow diagram showing a computer-executed method for automatic discovery of application infrastructure according to an embodiment;

FIG. 2 is a process flow diagram showing a computer-executed method for automatic discovery of application infrastructure according to an embodiment;

FIG. 3 is a block diagram showing a synthetic transaction according to an embodiment;

FIG. 4 is a block diagram of a system that may automatically discover an application infrastructure for actively monitored transactions according to an embodiment; and

FIG. 5 is a block diagram showing a non-transitory, computer-readable medium that stores code for automatic discovery of application infrastructure for actively monitored transactions according to an embodiment.

### DETAILED DESCRIPTION

Embodiments of the invention provide a tool for the automatic discovery of application infrastructure. Synthetic transactions may be used to provide details regarding the application infrastructure. Synthetic transactions are artificial transactions that have no inherent value, but can be used to monitor the performance and availability of business transactions. These transactions may give monitoring teams insight into the status of business services including, but not limited to, buying, selling, and collaborating online. The performance and availability of the synthetic transaction may depend on a wide variety of application infrastructure components including but not limited to, web servers, application servers, databases, and messaging. These application components, in turn, may be affected by their underlying system infrastructure elements such as the hosts, network, servers, and memory.

Manually discovering application infrastructure with synthetic transactions is error prone. It is also cumbersome to maintain previously discovered static relationships. Moreover, manual monitoring may require specialized knowledge of the applications, requiring skilled staff. Likewise, having detailed knowledge of the application deployment in a particular system requires additional skilled staff. Manual monitoring may also contribute to a lack of correlation among various groups within the information technology (IT) portion of a business, resulting in the growth of information silos across the business organization. For example, one IT group may focus on the health of infrastructure components, while another IT group may focus on the health of transactions. The information gathered by each group is often not available to other groups. As a result, the business may experience higher costs in terms of effort duplication, efficiency, and lost productivity. Accordingly, the business may not realize the full value of its monitoring investment.

Thus, a monitoring team may find it useful to be able to quickly ascertain the dependency relationships between a synthetic transaction and its corresponding application component, and even further down to the corresponding system infrastructure. This information is useful for root cause analysis as well as also impact analysis. Further, this information allows any problems or issues within an application infrastructure to be isolated.

The performance and availability of a synthetic transaction depends on a wide variety of application infrastructure components, including the web servers, J2EE application servers, ASP.NET application servers, and various database and messaging components. For example, a bottleneck in the database can impact the performance of the synthetic transaction. Also, if the application server goes down, the synthetic transaction may not be available. Application infrastructure components, in turn, are affected by their underlying system infrastructure elements, such as the host and network.

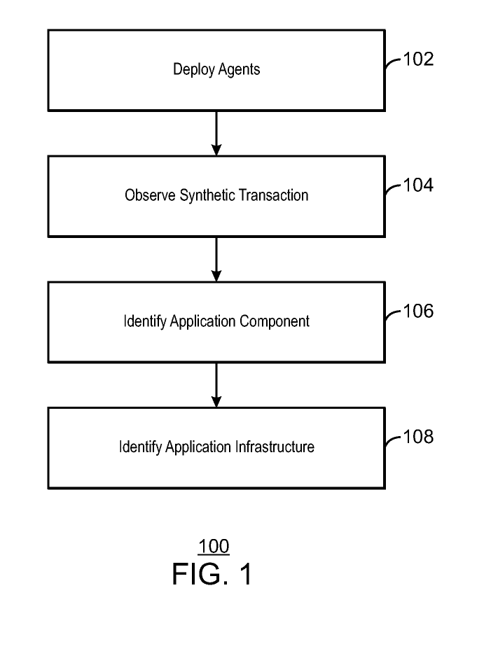

FIG. 1 is a process flow diagram showing a computer-executed method 100 for automatic discovery of application infrastructure according to an embodiment. At block 102, an activity and a synthetic transaction are observed using a diagnostic agent deployed into a process space of an application server. At block 104, the application components are identified based on the synthetic transaction, and at block 106, the application infrastructure underlying the application components is identified based on the application components.

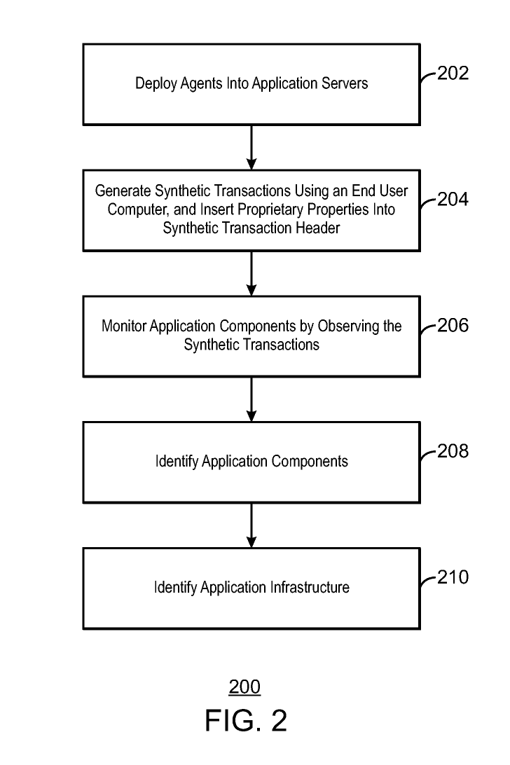

FIG. 2 is a process flow diagram showing a computer-executed method 200 for automatic discovery of application infrastructure according to an embodiment. At block 202, a diagnostic agent is deployed in the process space of an application server. The application sever may be, for example, J2EE or .NET application server. The diagnostic agent is typically an element of the monitoring application that resides within the application server.

At block 204, a synthetic transaction may be obtained from an end user computer. Additionally, proprietary properties may be inserted into the header of the synthetic transaction. In an embodiment, the synthetic transaction may simulate purchasing activity from an order placement e-commerce website.

At block 206, application components are monitored by observing the synthetic transactions. The diagnostic agent may be used to observe the synthetic transaction. Further, the diagnostic agent may use headers to discover the synthetic transaction name and the identity of its configuration item in an operational management database. The operational management database may contain up to date information related to the enterprise, while the configuration item may be data within the operational management database.

At block 208, the application components are identified. The application components may be identified by a diagnostic agent. For example, a diagnostic agent may identify the J2EE Application name for the invoked Servlet or Enterprise Java Bean (EJB) using Java. Similarly, the diagnostic agent may identify an IIS Web Directory for an ASP.NET application, or a .NET Application Domain for a .NET application. Additionally, the diagnostic agent may use a variety of application interfaces to identify the application components. For example, while deployed in a WebLogic J2EE Server, the diagnostic agent may use JMX interfaces to discover the attributes of the J2EE server. Likewise, a .NET agent may use the IIS Metabase to discover the relationship from a .NET AppDomain to the IIS Web Site and other components.

At block 210, the application infrastructure is identified. Infrastructure information may include, but is not limited to, host name, type, IP-addresses, and MAC addresses. The application infrastructure may be discovered by the diagnostic agent or by looking at various operating system level APIs.

By combining the knowledge of the infrastructure and the incoming synthetic transaction, the application infrastructure may be discovered. Accordingly, any issues within the application infrastructure may be quickly discovered and resolved. This proactive detection allows businesses to address service slowdowns and outages before their customers are negatively affected and choose to take their business elsewhere.

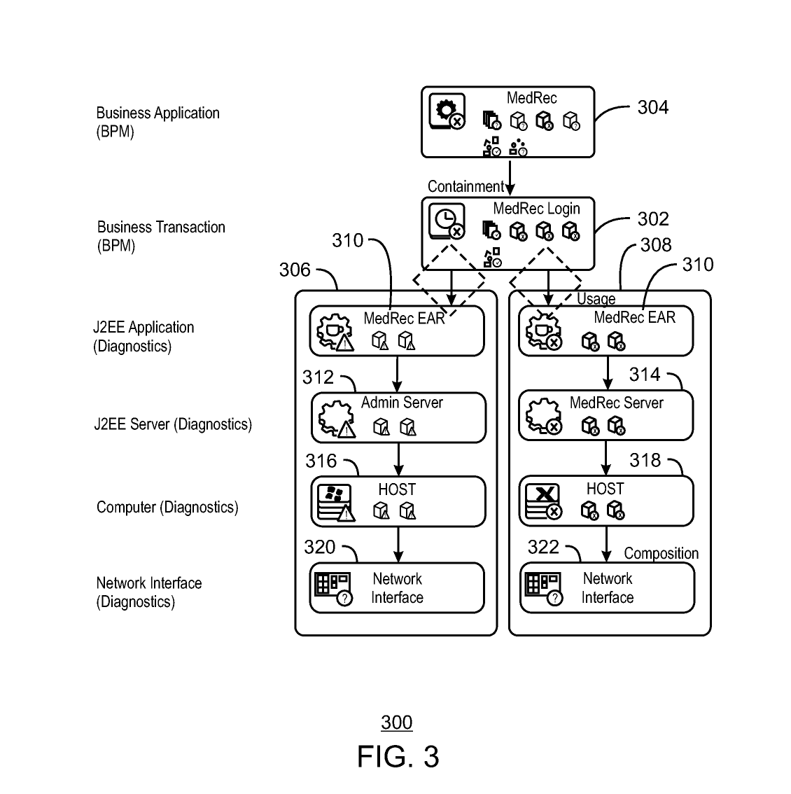

FIG. 3 is a block diagram showing a synthetic transaction according to an embodiment. MedRec Login 302 is a synthetic transaction that may be monitored. The synthetic transaction may be generated by business application MedRec 304. System 306 and System 308 both contain a diagnostic agent capable of observing MedRec Login 302. Within both systems there may be core components of a J2EE model as discovered by a diagnostic agent. These components include MedRecEAR 310, Admin Server 312, MedRec Server 314, host 316, host 318, Network Interface 320, and Network Interface 322.

MedRecEAR 310 may represent J2EE application code as deployed in an IT production environment. The Admin Server 312 and MedRec Server 314 may be J2EE Servers and host the J2EE Application MedRecEAR 310. Further, Admin Server 312 and MedRec Server 314 may make MedRecEAR 310 available to various users over HTTP and other protocols. The Admin Server 312 and MedRec Server 314 may be hosted on host 316 and host 318, respectively. The host 316 interfaces with the network through the Network Interface 320, while the host 318 interfaces with the network through the Network Interface 322. For ease of description, each of these components have been described separately, but the components may be software components that may exist within the same process space.

When the synthetic transaction MedRec Login 302 reaches Admin Server 312 and MedRec Server 314, the diagnostic agent may be able to identify the incoming the synthetic transaction MedRec Login 302 and connect it to the corresponding J2EE application MedRecEAR 310. Additionally, the performance, availability, health, or status of the system may be propagated from the lower levels, such as host 316 or host 318, to the higher levels such as J2EE application Med RecEAR 310.

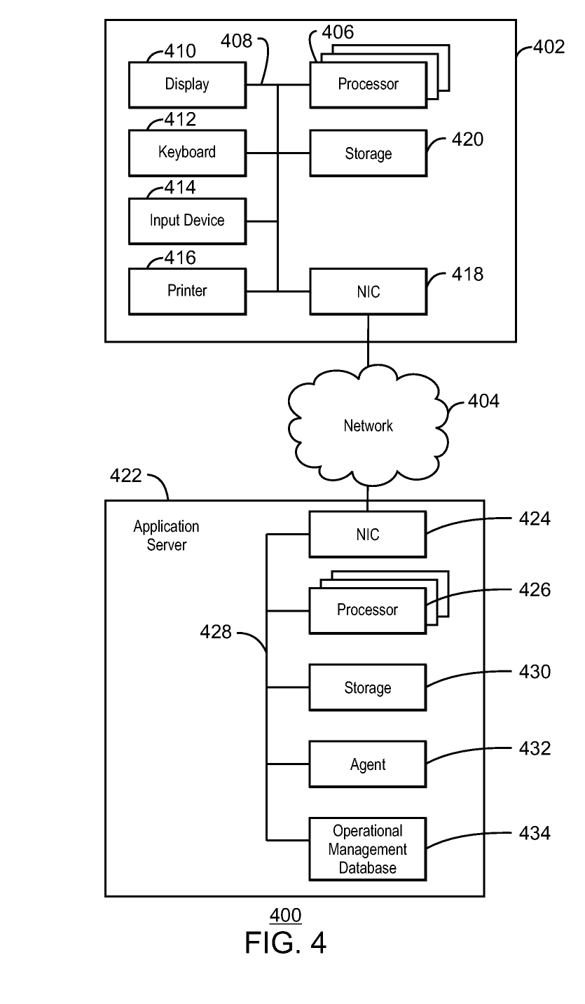

FIG. 4 is a block diagram of a system that may automatically discover application infrastructure using synthetic transactions according to an embodiment. The system is generally referred to by the reference number 400. Those of ordinary skill in the art will appreciate that the functional blocks and devices shown in FIG. 4 may comprise hardware elements including circuitry, software elements including computer code stored on a tangible, a machine-readable medium, or a combination of both hardware and software elements. Additionally, the functional blocks and devices of the system 400 are but one example of functional blocks and devices that may be implemented in an embodiment. Those of ordinary skill in the art would readily be able to define specific functional blocks based on design considerations for a particular electronic device.

The system 400 may include an end user computer 402 in communication over a network 404. The network 404 may be connected to a number of end user computers, but, for ease of description, one end user computer 402 is shown. As illustrated in FIG. 4, the end user computer 402 may include one or more processors 406 which may be connected through a bus 408 to a display 410, a keyboard 412, one or more input devices 414, and an output device, such as a printer 416. The input devices 414 may include devices such as a mouse or touch screen. The processors 406 may include a single core, multiples cores, or a cluster of cores in a cloud computing architecture. The end user computer 402 may also be connected through the bus 408 to a network interface card (NIC) 418. The NIC 418 may connect the end user computer 402 to the network 404.

The end user computer 402 may have other units operatively coupled to the processor 406 through the bus 408. These units may include non-transitory, computer-readable storage media, such as storage 420. The storage 420 may include any combinations of hard drives, read-only memory (ROM), random access memory (RAM), RAM drives, flash drives, optical drives, cache memory, and the like. Further, the storage may include a memory device storing processor-executable code adapted to automatically discover application infrastructure.

The network 404 may be a local area network (LAN), a wide area network (WAN), or another network configuration. The network 404 may include routers, switches, modems, or any other kind of interface device used for interconnection. The network 404 may connect to an application server 422. Several application servers may connect to network 404, but, for ease of description, only one application server 422 is shown. Through the network 404, several end user computers and application servers may communicate with one another.

The application server 422 may communicate with network 404 through NIC 424. The application server 422 may include one or more processors 426 which may be connected through a bus 428 to a storage 430, an agent 432, and an operational management database 434. The agent 432 may be an element of a monitoring application that resides on application server 422.

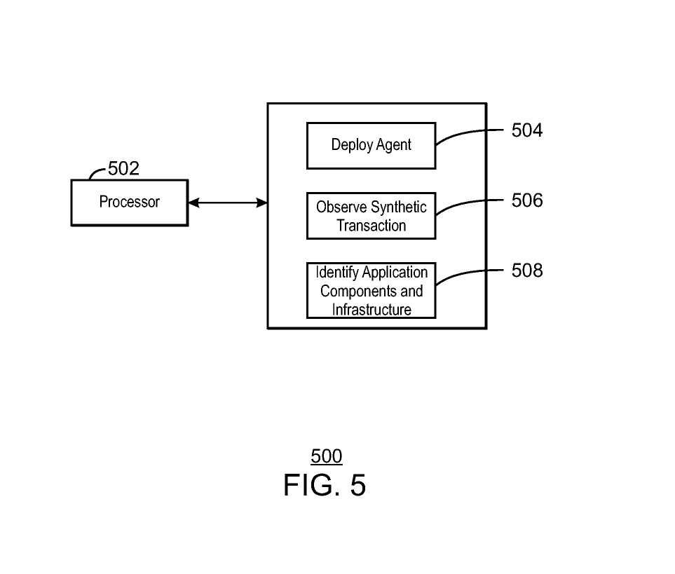

FIG. 5 is a block diagram showing a non-transitory, computer-readable medium that stores code for automatic discovery of application infrastructure using synthetic transactions. The non-transitory, computer-readable medium is generally referred to by the reference number 500.

The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices.

Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices.

A processor 502 generally retrieves and executes the computer-implemented instructions stored in the non-transitory, computer-readable medium 500 for automatic discovery of application infrastructure. At block 504, an observation module observes an activity and a synthetic transaction using a diagnostic agent deployed into the process space of an application server. At block 508, an identification module may identify application components on the synthetic transaction. Additionally, the identification module may identify the application infrastructure based on the underlying application components.

What is claimed is:

1. A computer system for automatic discovery of application infrastructure, comprising:
a processor that is adapted to execute stored instructions; and
a memory device storing processor-executable code adapted to:
observe an activity and a synthetic transaction using a diagnostic agent deployed into a process space of an application server;
identify application components based on the synthetic transaction; and
identify the application infrastructure based on the application components.

2. The system recited in claim 1, wherein the application server is a J2EE or .NET application server.

3. The system recited in claim 1, wherein the memory stores processor-executable code adapted to insert proprietary properties into a header of the synthetic transaction.

4. The system recited in claim 1, wherein the memory stores processor-executable code adapted to use a header of the synthetic transaction to discover a transaction name and the identity of its configuration item in an operational database.

5. The system recited in claim 1, wherein the memory stores processor-executable code adapted to identify the application component by identifying a J2EE Application name, an IIS Web Directory for an ASP.NET application, or a .NET Application Domain for a .NET application.

6. The system recited in claim 1, wherein the memory stores processor-executable code adapted to use the synthetic transaction to simulate order placement at an e-commerce website.

7. The system recited in claim 1, wherein the memory stores processor-executable code adapted to monitor the application components using the synthetic transaction.

8. The system recited in claim 1, wherein the memory stores processor executable-code adapted to obtain the synthetic transaction from an end user computer.

9. A method for automatic discovery of application infrastructure, comprising:
observing an activity and a synthetic transaction using a diagnostic agent deployed into a process space of an application server;
identifying application components based on the synthetic transaction; and
identifying the application infrastructure based on the application components.

10. The method recited in claim 9, wherein identifying application components includes discovering attributes of the application server.

11. The method recited in claim 9, comprising inserting proprietary properties into a header of the synthetic transaction.

12. The method recited in claim 9, comprising monitoring the application components using a header of the synthetic transaction to discover a synthetic transaction name and the identity of its configuration item in an operational database.

13. The method recited in claim 9, wherein identifying the application components comprises identifying the application component by identifying one of a J2EE Application name, an IIS Web Directory for an ASP.NET application, or a .NET Application Domain for a .NET application.

14. The method recited in claim 9, comprising using the synthetic transaction to simulate order placement at an e-commerce website.

15. The method recited in claim 9, comprising monitoring the application components by using the diagnostic agent to observe the synthetic transaction.

16. The method recited in claim 9, comprising obtaining the synthetic transaction from an end-user computer.

17. A non-transitory, computer-readable medium, comprising code configured to direct a processor to:
observe an activity and a synthetic transaction using an observation module that includes a diagnostic agent deployed into a process space of an application server;
identify application components based on the synthetic transaction using an identification module; and
identify the application infrastructure based on the application components using the identification module.

18. The computer-readable medium recited in claim 17, comprising code configured to direct the processor to:
insert proprietary properties into a header of the synthetic transaction; and
use the header of the synthetic transaction to discover a transaction name or the identity of its configuration item in an operational database.

19. The computer-readable medium recited in claim 17, comprising code configured to direct the processor to identify an application component by identifying a J2EE Application name, an IIS Web Directory for an ASP.NET application, or a .NET Application Domain for a .NET application using the identification module.

20. The computer-readable medium recited in claim 17, comprising code configured to direct the processor to monitor the application components using the synthetic transaction, or use an end user computer to generate the synthetic transaction.
